(19) United States
(12) Patent Application Publication
(10) Pub. No.: US 2024/0315529 A1
(43) Pub. Date: Sep. 26, 2024

(54) DOORMAT STRUCTURE COMPRISING SAFETY BOX/ES

(71) Applicant: Len Donell Miller, JR., Lancaster, TX (US)

(72) Inventor: Len Donell Miller, JR., Lancaster, TX (US)

(21) Appl. No.: 18/387,542

(22) Filed: Nov. 7, 2023

Related U.S. Application Data
(60) Provisional application No. 63/491,848, filed on Mar. 23, 2023.

(51) Int. Cl. A47L 23/26; E05B 65/00

(52) U.S. Cl. CPC A47L 23/266; E05B 65/00

(57) ABSTRACT

The presently disclosed subject matter relates generally to a doormat structure which comprises at least one safety box. The doormat structure comprises a mat and a body. The body comprises at least one horizontal panel and at least one safety box. The safety box may be lockable. The mat is positioned upon the body and functions similarly to a traditional doormat. The safety box/es is inconspicuously positioned within the doormat structure while being accessible to a user. Thus, the presently disclosed doormat structure allows a user to safely store various small items outdoors inconspicuously.

### TECHNICAL FIELD

The presently disclosed subject matter relates generally to a doormat structure which comprises at least one safety box. The safety box/es is inconspicuously incorporated in the doormat structure and may be lockable. Thus, the presently disclosed doormat structure allows a user to safely store various small items outdoors inconspicuously.

### BACKGROUND

Practically every home owner is familiar with the problem of being locked outside their home without access to door keys, car keys, phone, or credit cards. Most home owners also face the dilemma of where to leave essential items, such as door keys, for relatives, pet care-takers, etc., while they are away. Many resort to hiding keys and other essentials in places such as under a flower pot next to the door or simply under a doormat, only to find to their dismay that the “hiding place” was too obvious to unintended persons. Otherwise, a very complicated and unobvious hiding place may be too hard to find by the intendent users, and in time, even by the homeowner.

Some solutions were attempted to solve this problem, notably stone-look-alike gadgets which have a small storage space. However, it is very easy to lose these small “stones” in a yard, whether moved by children, animals, or gardeners. In addition, the storage provided in them is usually not enough for more than a key, and the storage space which they offer is not lockable.

There is a need in the field for an inconspicuous, lockable, reasonably spacious, and reliably-found outdoors storage space. The presently disclosed doormat structure provides all the above.

### SUMMARY

In accordance with the present invention, various embodiments of a doormat structure comprising safety box/es and methods of operation thereof are disclosed. In one embodiment, the presently disclosed doormat structure comprises: a body; the body comprises at least one horizontal panel and at least one safety box, the at least one safety box comprising a storage compartment, the storage compartment comprising a storage space; a mat, wherein the mat is positioned upon the at least one horizontal panel.

In some embodiments, the body further comprises a vertical wall which extend around the perimeter of the at least one horizontal panel/s.

In some embodiments, the least one safety box is attached to at least one horizontal panel.

In some embodiments, the attachment of the at least one safety box to the at least one horizontal panel is removable or unremovable.

In some embodiments, the at least one safety box is lockable via a lock.

In some embodiments, the lock is selected from a group comprising a combination type lock, latch, bolt lock, keypad lock, smart lock, set of one or more magnet(s), and pin tumble lock.

In some embodiments, the lock is located in a location selected from a group comprising a position at the perimeter of the body which is accessible to a user, a position at the top side of a horizontal panel which is positioned underneath the mat, a position at the bottom side of a horizontal panel.

In some embodiments, the safety box is in an open or closed position; and wherein when the safety box is in an open position the storage space is accessible to a user.

In some embodiments, the storage compartment comprises at least one front portion, and wherein when the safety box is in a closed position the at least one front portion is positioned at the perimeter of the body.

In some embodiments, when the safety box is in an open position the at least one front portion, and thus the storage compartment, is pulled outwards away from the perimeter of the body, thus exposing the storage space.

In some embodiments, the at least one horizontal panel comprises an elastic and weatherproof material; and wherein the material is selected from a group comprising vinyl, polyvinyl chloride (PVC), rubber, silicone, neoprene, and polyethylene foam.

In some embodiments, the safety box comprises material selected from a group comprising ceramic fibers, metal, plastic, steel, and aluminum.

In some embodiments, the mat comprises a material selected from a group comprising nylon, polypropylene, coir, foam, cotton, microfiber, fabric, fiber brush, or natural rubber.

In some embodiments, the at least one horizontal panel has a thickness in the range of 0.5 to 1 inch.

In some embodiments, the body comprises one horizontal panel and at least one safety box attached to the said one horizontal panel.

In some embodiments, the body comprises two horizontal panels wherein at least one of the said horizontal panels is attached to at least one safety box; and wherein the two horizontal panels are attached together in a manner according to which the said panels substantially overlap horizontally.

In some embodiments, a first panel of the two horizontal panels is attached to at least one safety box and a second panel of the two horizontal panels is not attached to at least one safety box, and wherein the shape and perimeter of the first horizontal panel and attached at least one safety box are substantially the same as the shape and perimeter of the second horizontal panel.

In some embodiments, the attachment of the two horizontal panels to each other is achieved via the use of a method selected from a group comprising a use of an adhesive/s, thermal boding process, or mechanical fastener/s.

In some embodiments, the mechanical fastener/s is selected from a group comprising screws, nails, nuts, bolts, washers, anchors, rivets, clips, staples, tacks, or braces.

In some embodiments, the body and mat have substantially the same shape and perimeter; and wherein the shape of the body and mat is selected from a group comprising rectangle, square, circle, half-circle, ring, trapezoid, rhombus, ovel, and half-oval.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a perspective view of an example of the presently disclosed doormat structure wherein the doormat structure comprises one safety box and wherein the safety box is in a closed position;

FIG. 2 illustrates a perspective view of the doormat structure of FIG. 1, wherein the safety box is in an open position;

FIG. 3 illustrates a perspective view of the open safety box of FIG. 2;

FIG. 4 illustrates a perspective view of an example of a presently disclosed safety box, wherein the safety box is in a closed position and comprises a lock;

FIG. 5 illustrates a perspective view of the safety box of FIG. 4 wherein the safety box is in an open position;

FIG. 6 illustrates a perspective view of another example of the presently disclosed doormat structure wherein the doormat structure comprises one safety box and wherein the safety box is in a closed position; and,

FIG. 7 illustrates an exploded view of the doormat structure of FIG. 6.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides examples and embodiments of a doormat structure which comprises at least one safety box. It is a long-standing problem for most home owners or business owners, where and how to store essentials, such as car keys or door keys, outdoors in a concealed and yet easily-found and safe manner. The presently disclosed doormat structure offers a solution in that while functioning and appearing as a traditional doormat, it comprises at least one safe and inconspicuous safety box. In some embodiments, the presently disclosed safety box is lockable and positioned in the doormat structure in a manner according to which it comprises at least one portion located at the perimeter of the doormat structure. This portion (referred to herein as front portion), while located at the perimeter of the structure, as mentioned above, and facing the outside of the doormat structure, is inconspicuous, meaning, it is generally not visible to an un-intendent user, for example, a casual passer-by.

The presently disclosed doormat structure generally comprises a body and mat which lays upon the body. The mat is generally some type of a doormat traditional in the art and proportioned for the dimensions (for example, length and width) of the body. The body comprises at least one horizontal panel and at least one safety box, for example, a lockable safety box. In some embodiments, the at least one safety box is integrated with, or attached to, the horizontal panel in such way that the portion of the safety box located at the perimeter of the body is substantially flush with the body's perimeter. This, and the mat which is positioned upon the body, achieve the effect of concealing the presence of the safety box. In addition, as the presently disclosed doormat structure may have any shape traditional in the art for a doormat, for example, a rectangle, the doormat structure may be positioned outdoors in such manner that the front portion faces the house, or business, door and therefore not visible from the street/other side of the doormat structure.

The at least one safety box may be a lockable safety box, the lock may be of any type traditionally used in the art. In some embodiments, the lock is also located at the perimeter of the body, allowing a user to conveniently unlock the safety box and open it. In some embodiments, opening the safety box comprises pulling outwards (away from the body) a drawer or a tray, and retrieving, or storing, items as desired. Thus, the presently disclosed doormat structure can be used to safely store outdoors and retrieve various items such as mobile phones, keys, credit cards, etc.,

The presently disclosed doormat structure is substantially flat, i.e., the cross section of the body is much smaller in its vertical dimension than it is in its horizontal dimension. However, the body is sufficiently thick to accommodate one or more secure safety box/es. Furthermore, in some embodiments, the body is sufficiently thin that it does not pose an obstruction to the normal operation of a hinged door, i.e., a hinged door is able to swing open over it without being obstructed by the presently disclosed doormat structure positioned in front of it.

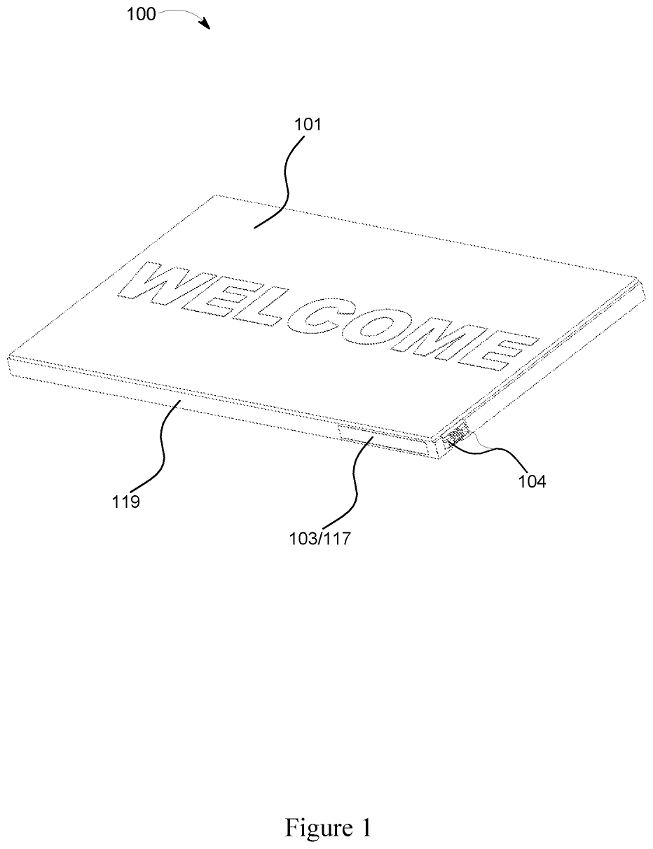

Referring now to FIGS. 1, 6, and 7, an illustration of an example of the presently disclosed doormat structure 100 is shown. Generally, the doormat structure 100 comprises a body 118 and a mat 101. In some embodiments, the body 118 comprises at least one horizontal panel 102 (e.g., 102a, 102b, 102c, . . . ) and at least one safety box 103. The body 118 has a thickness, shape, and a perimeter. In some embodiments, the thickness of the body 118 is equal to the thickness of the horizontal panel/s 102 which it comprises. In some embodiments, the thickness of each horizontal panel 102 may be, as an unlimiting example, in the range of about 0.25-1.5 inch. More specifically, the thickness of each horizontal panel 102 may be, or be about, without limitation, 0.25, 0.5, 0.75, 1, 1.25, or 1.5 inches. The mat 101 is positioned on the body 118. In some embodiments, the area of the mat 101 is substantially the same as that of the body 118. In some other embodiments, the area of the mat 101 may be bigger or smaller than that of the body 118. In some embodiments, the mat 101 simply lays upon the body 118, i.e., there is no attachment between the mat 101 and the body 118. In some other embodiments, the mat 101 is removably attached to the body 118. It is expressly contemplated herein that any means traditionally used in the art to achieve a removable attachment are within the scope of this disclosure. For example, the removable attachment of the mat 101 to the body may be achieved via the use of adhesive/s (such as tape adhesives), a hook and loop fastener, snap fasteners, magnets power attachment, or combination thereof. In some embodiments, maintaining the mat 101 in position upon the body 118 is achieved via friction. In some embodiments, friction between the bottom surface of the mat 101 and the top surface of the horizontal panel 102 proximal to the mat 101 is enhanced via coating on either, or both, surfaces. Such coating may comprise, without limitation, silicon, rubber, or combination thereof. In some other embodiments, the mat 101 is permanently attached to the body 118. Any means know in the art may be used to permanently attach the mat 101 to the body 118 including, but not limited to, lamination, adhesives, thermal binding, mechanical attachment, or combinations thereof. Means of mechanical attachment may include, without limitation, screws, nails, nuts, bolts, washers, anchors, rivets, clips, staples, tacks, or braces, or combinations thereof.

The presently disclosed doormat structure 100 is designed for traditional use, e.g., for wiping a person's or animals' feet. Therefore, the presently disclosed mat 101 may comprise any material traditionally used in the art for this purpose. Some unlimiting example of materials which may be used to fashion the mat 101 include nylon, polypropylene, coir, foam, cotton, microfiber, fabric, fiber brush, natural rubber, or combinations thereof. The presently disclosed doormat structure 100 has a horizontal perimeter which defines a shape. The shape may be any shape traditionally used for a doormat, or any other non-standard shape. Unlimiting examples of suitable shapes for the presently disclosed doormat structure 100 include, a square, squarish, rectangle, circle, half-circle, oval, a ring, half-ring, a trapezoid, a rhombus, or half-oval.

The safety box 103 may be in an open, partly open, or closed position, it is depicted in a closed position in FIG. 1. In some embodiments, the safety box 103 comprises at least one side, a front portion 117, which is positioned at the perimeter of the body 118 when the safety box 103 is in a closed position. In some embodiments, the front portion 117 is substantially flush with the rest of the vertical perimeter of the body 118 when the safety box 103 is in a closed position, making the presence of the safety box 103 inconspicuous, while still accessible to a user. In some other embodiments, according to which the safety box 103 is lockable, a component of the lock 104 may also be positioned at the perimeter of the body 118, and thus accessible to a user desiring to unlock, or lock, the safety box 103.

In the embodiment shown, the doormat structure 100 comprises one safety box 103. However, in some other embodiments, the doormat structure 100 may comprise two, three, four, or more safety boxes 103. For example, a doormat structure 100 which comprises two safety boxes 103, may have one safety box 103 positioned as depicted in the example of FIG. 1 and a second safety box 103 accessible only upon removal, or partial removal, of the mat 101 from the body 118. One safety box 103 may be lockable while the other is not, or both may be lockable, or both unlockable. Alternatively, both safety boxes 103 may comprise at least one front portion 117. Any such configurations are within the scope of this disclosure.

In some embodiments, the body 118 further comprises vertical walls 119 which extend around the perimeter of the horizontal panels 102. In some embodiments, the vertical walls 119 have a height which is substantially the same as the combined height of the horizontal panels 102 comprised in the body 118. Such vertical walls 119 may be used to improve the visual appeal of the doormat structure 100 and/or provide surface/s for branding/customization The above-mentioned walls 119 may be also used to further conceal the presence of the safety box 103 and/or lock 104 from a casual observer.

In some embodiments, the horizontal panel/s 102 and the vertical walls 119 are constructed of the same materials. In some other embodiments, the horizontal panel/s 102 and the vertical walls 119 are not constructed of the same materials. Any material traditionally used in the art for fashioning outdoor structures or doormats is applicable for fashioning the presently disclosed horizontal panel/s 102 and vertical walls 119. In general, a material which is compressible, cushioning, durable, elastic, and weatherproof is contemplated herein. Unlimiting examples include any type of polymeric material, vinyl, polyvinyl chloride (PVC), rubber, silicone, neoprene, polyethylene foam, fabric, fiber brush, wood, metal, or combinations thereof.

In some embodiments, whether the body 118 comprises, or does not comprise, vertical walls 119, components of the at least one safety box/es 103, including front portion 117 and/or lock 104, 105, are designed to be visually like the perimeter of the horizontal panel/s 102 and/or the vertical walls 119, to prevent easy detection by a casual observer. Visual concealment includes using characteristics such as color, texture, design, and reflectance.

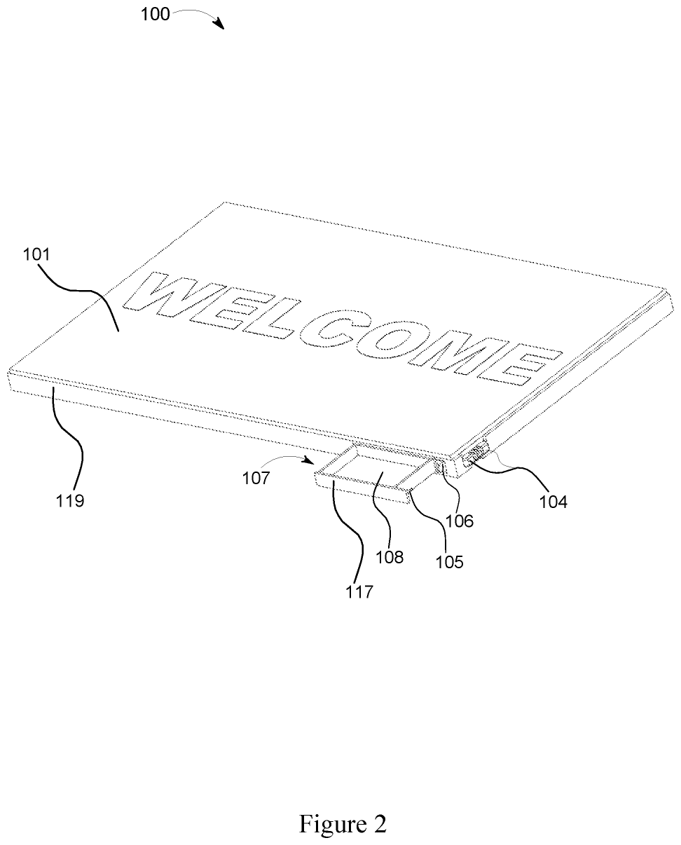

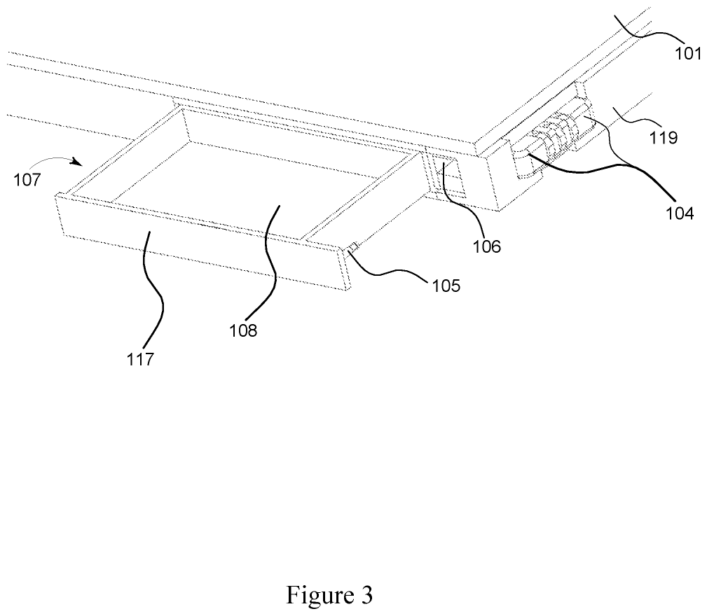

Referring now to FIGS. 2 and 3, the example of the doormat structure 100 depicted in FIG. 1 is shown, illustrating the safety box 103 in an open position. Generally, the currently disclosed safety box 103 comprises a storage compartment 107 comprising a storage space 108. In some embodiments, the storage compartment 107 is simply the cavity, or inside space, of the safety box 103. According to this embodiment, the storage compartment 107 and the storage space 108 are basically the same and accessible to a user upon opening the safety box 103 via the front portion 117. Opening the front portion includes in its scope traditionally known methods for opening a door or a drawer. Such methods include pulling the front portion 117 outwards (away from the body 118), rotating, e.g., using hinge/s, the front portion 117 to one side (in the same manner of opening a traditional door), rotating, e.g., using hinge/s, the front portion 117 upwards/downwards, sliding the front portion 117 to one side in the same manner of opening a sliding door, or detaching the front portion 117 from the body 118 (according to this embodiment the front portion 117 can be re-attached). In any of the embodiments disclosed herein, the front portion 117 may comprise, on its side facing the storage space 108, portions of its side facing the storage space 108, or the perimeter of its side facing the storage space 108, a coating of a material, for example, a waterproof material such as silicone, rubber, silicone rubber, silicone-based material, polymeric material, or combinations thereof.

The embodiment according to which the storage compartment 107 and the storage space 108 are basically the same, is especially suitable to a situation wherein at least one safety box 103 is meant for a limited storage, for example one, or a few, key/s. In that case, it would be convenient for a user, upon opening the front portion 117, to reach in the storage space 108 with a finger, or finger/s, and retrieve the stored item/s. This embodiment also allows for a smaller, and therefore even less conspicuous, front portion 117.

In some other embodiments, the storage area 108 of at least one safety box 103 is sufficient to contain larger items. Examples of items which may be stored in a larger storage space 108 include, but are not limited to, keys, keyrings, NFC key fobs, letters, envelopes, small packages, smartphones, wallets, pieces of jewelry, and the like. Indeed, any dimensions of a storage space 108 are within the scope of the present disclosure. The storage space 108 may also be of any shape, including, but not limited to, a square, squarish, rectangle, circle, half-circle, oval, half-ring, a trapezoid, a rhombus, or half-oval. In the embodiment according to which the storage space 108 is rectangular some exemplary dimensions include width which is in a range of 3-9 inches, depth (length) which is in a range of 2-6 inches, and height which is in a range of 0.25-1.5 inches. More specifically, exemplary dimensions of a rectangular storage space 108 include width which is, or is about, 3, 3.5, 4, 4.5, 5, 5.5, 6, 6.5, 7, 7.5, 8, 8.5, or 9 inches, depth (length) which is, or is about, 2, 2.5, 3, 3.5, 4, 4.5, 5, 5.5, or 6 inches, and height which is, or is about, 0.25, 0.5, 0.75, 1, 1.25, or 1.5 inches. Even more specifically, exemplary dimensions of a rectangular storage space 108 are, or is about, width 6 inches, depth 3 inches, and height 0.5 inch. In the embodiment according to which the storage space 108 is squarish some exemplary dimensions include width and depth which are in a range of 3-9 inches, and height which is in a range of 0.25-1.5 inches. More specifically, exemplary dimensions of a squarish storage space 108 include width and depth which are, or are about, 3, 3.5, 4, 4.5, 5, 5.5, 6, 6.5, 7, 7.5, 8, 8.5, or 9 inches, and height which is, or is about, 0.25, 0.5, 0.75, 1, 1.25, or 1.5 inches.

In the embodiment, illustrated in FIGS. 2 and 3, the safety box 103 comprises a safety compartment 107 which comprises a storage space 108. The storage compartment 107 may be any type of a storage compartment traditionally used in the art such as a drawer (illustrated), bin, box, or a tray. In some embodiments, the storage compartment 107 may comprise more than one unit/s of storage, each unit comprising a distinct storage space 108. In the example illustrated, the front portion 117 is part of the storage compartment 107, thus when the front portion is opened by a user (in the exemplified embodiment of FIGS. 1-3: by pulling it away from the body 118), the storage compartment 107 is moved away from the body 118 and thus the storage space 108 it comprises becomes easily accessible for a user. In any of the embodiments disclosed herein, the front portion 117 may be part of the storage compartment 107. In any of the presently disclosed embodiments, the front portion 117 may further comprise an element usable for opening the front portion 117. Such element may be, for example, an indent or protrusion which, while concealed, may be used by a user to handle the front portion 117.

According to some embodiments, while the storage compartment 107 is pulled outwards and away from the body 118, it remains attached to the safety box 103 and therefore the body 118, similarly to the functionality of a traditional drawer which can slide on its runners. According to some other embodiments, upon opening the front portion 117, the safety compartment 107 may be pulled out of the safety box 103 and therefore the body 118. According to this embodiment of the presently disclosed doormat structure 100, upon opening the front portion 117 (for example, after unlocking the safety box 103), a user can take the storage compartment 107 with her/him and remove, or store, items as desired.

In some embodiments, the presently disclosed safety box 103 is unlockable, thus the security the stored items rely on the concealment of the safety box within the doormat structure 100. In some other embodiments, the presently disclosed safety box 103 is lockable. As discussed above, a doormat structure 100 may comprise more than one safety box/es 103, lockable, unlockable, or combination thereof. In the embodiment according to which the safety box 103 is lockable and the safety box is locked, access to the storage space is controlled by the lock 104, 105. In some embodiments, once the locked safety box 103 is unlocked, or when the front portion 117 rotate/slide to the side to open, the storage space 108 is accessible to a user. For example, once the safety box 103 is unlocked, the storage compartment 107 may pop to the outside of the perimeter of the body 118, for example, when a spring mechanism is involved. In some other embodiments, once the locked safety box 103 is unlocked, a user must perform another step to access the storage space 108. For example, the step may comprise pushing a button, or operating a toggle, to pop the front portion 117 open or pop the storage compartment 107 towards the outside of the body 118. This may involve, for example, a spring-operated mechanism. As another example, the step may comprise a button, or toggle, which releases a latch, or release a closure achieved via magnetic power (magnetic push latch). In some other embodiments, the step of exposing the storage space after unlocking simply involves the user manually rotating or pulling the front portion 117. The above-described step may be necessary also for exposing the storage space 108 of an unlockable safety box 103. Therefore, in some embodiments the presently disclosed safety box 103 may be locked, unlocked but closed, or open.

An example of an open, lockable, safety box 103 is depicted in FIGS. 2 and 3, wherein the lock 104, 105 is a combination-type lock. In some embodiments, a component of the lock 104, 105, necessary for unlocking, is accessible to the user. In the example illustrated, the portion of the lock 104, 105 which comprises the code combination 104 is positioned at the perimeter of the body 118 and thus is accessible to a user, while the pin 105, which enables locking, is attached to the storage compartment 107. An opening 106 in the perimeter of the body 118 enables the pin 104 to interact with the combination code portion 104 to allow for the locking and unlocking. In some other embodiments, such portion of the lock 104 may not be accessible to a user from the outside of the doormat structure 100 (as will be discussed below). In some other embodiments, the said portion of the lock may be positioned anywhere else on the outside of the doormat structure including on, or next to, the front portion 117.

The presently disclosed lock 104, 105 may be any type of lock known in the art including, latch, bolt, magnet-operated lock, pin tumble lock, electronic lock (for example, such as a keypad lock or an NFC lock), passcode lock, combination lock (shown), electromagnetic lock, padlock, or smart lock, without limitation.

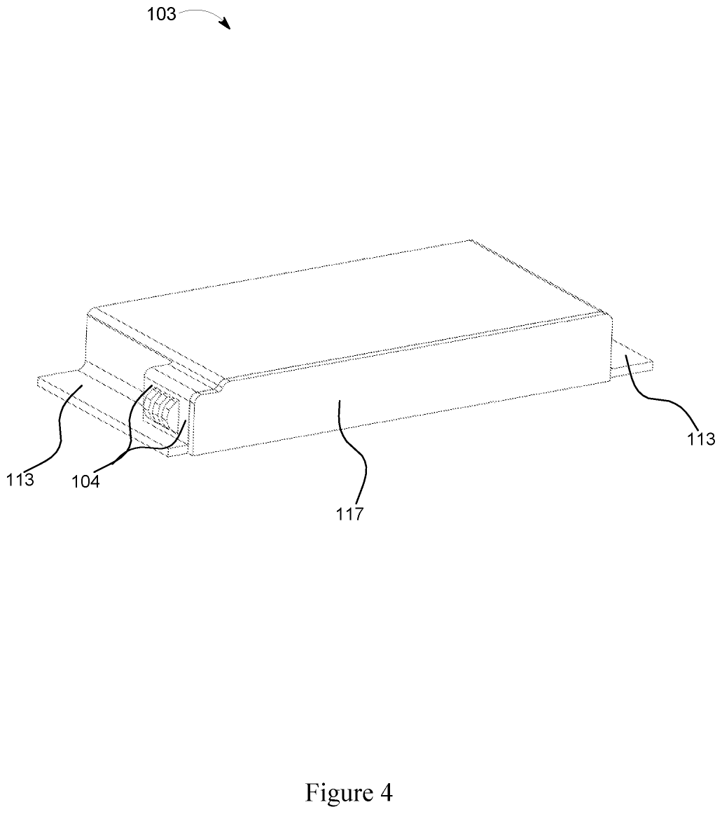

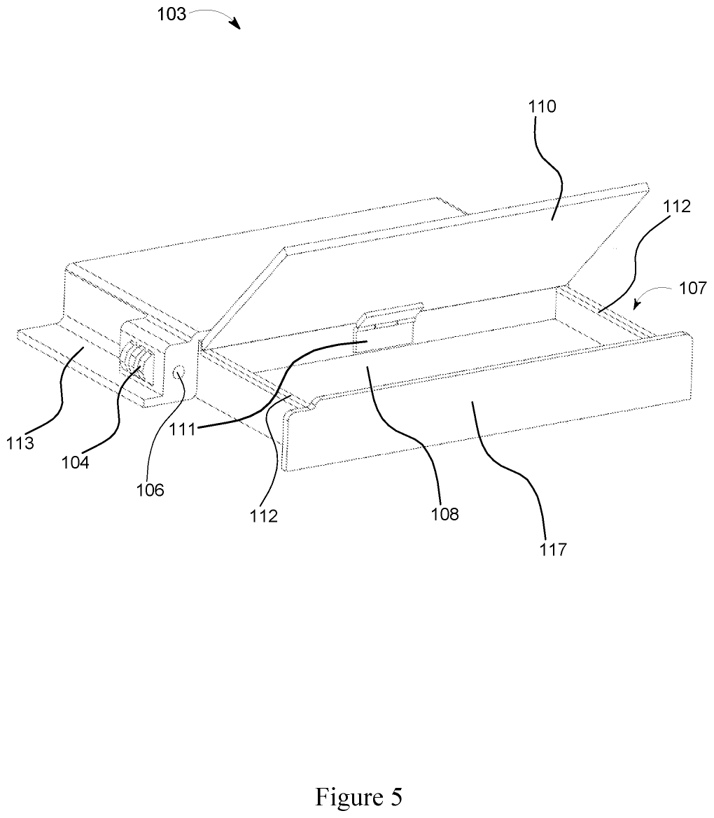

Moving now to FIGS. 4 and 5, an example of a safety box 103 is illustrated wherein the safety box 103 comprises a front portion 117, a storage compartment 107 comprising a storage space 108, lock 104, 105, and at least one attachment portion 113. The safety box 103 is illustrated in a closed position in FIG. 4 and in an open position in FIG. 5. In the embodiment shown, the storage compartment 107 is a drawer-type storage compartment 103. In some embodiments, upon unlocking the lock 104, 105, the storage compartment 103 is propelled forward (away from the body 118) for example, by a released spring power. According to the embodiment of FIGS. 4 and 5, the storage compartment 107 further comprises a lid 110 which serves to protect the content/s of the storage space 108. The lid 110 rotate, via hinge/s 111, to close or open the storage space 108. In some embodiments the hinge 111 is a spring-loaded hinge, and therefore, the spring 111 operates to rotate the lid 110 to an open position (shown) once the storage compartment 107 is outside of the safety box 103. In some embodiments, portions of the storage compartment 107 comprise a coating of a sealing material 112, for example, a waterproof material 112 such as silicone, rubber, silicone rubber, silicone-based material, polymeric material, or combinations thereof. The said portions may include the top perimeter of the storage compartment 103 drawer and/or the inside (the side which faces the storage space 108) perimeter of the lid 110. Thus, the lid 110 maintains a weatherproof seal to protect the storage space 108 while the storage compartment 107 is in the closed/locked configuration.

To enable the function of the presently disclosed doormat 100 as a traditional doormat while protecting the content/s of the safety box 103, the safety box 103 must be resilient enough to withstand weight applied upon it from people standing or stepping on it, packages placed upon it, etc., In particular, the storage compartment 107 comprising the storage space 108 must be mechanically robust to withstand a normal operation of a doormat without collapsing and/or allowing the object(s) stored inside to be damaged. To this end, the storage compartment 107 may comprise, in some embodiments, mechanical supports such as braces, ribs, columns, and the like. In some embodiments, the safety box 103, and/or horizontal panel/s 102 or portions of the horizontal panel/s proximal to the safety box 103, may comprise materials such as inlaid ceramic fibers, metallic inserts, structural plastic inserts, and the like. In yet some other embodiments, the safety box 103, and/or horizontal panel/s 102 or portions of the horizontal panel/s proximal to the safety box 103, may also comprise materials such as, without limitation, stamped, bent, and/or welded metal sheets (for example, steel or aluminum).

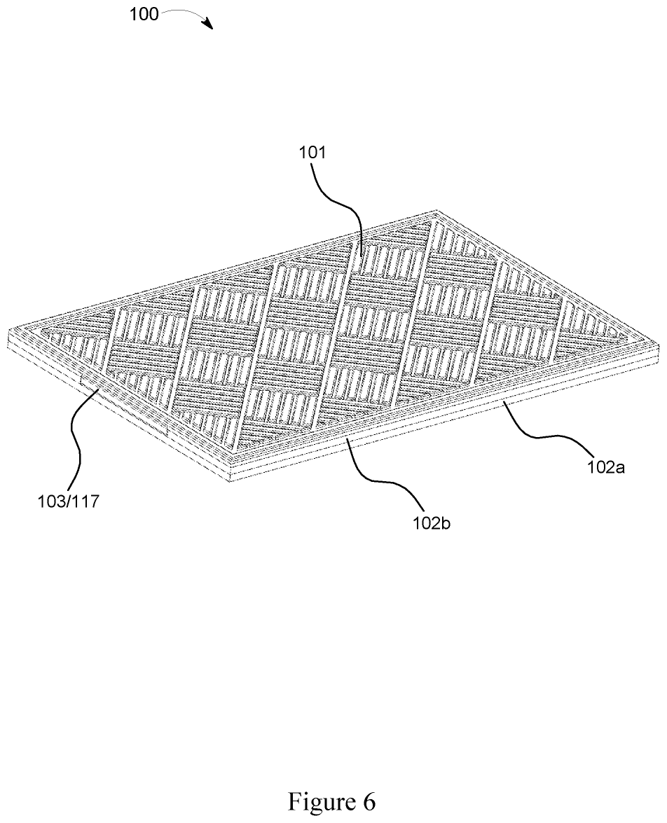

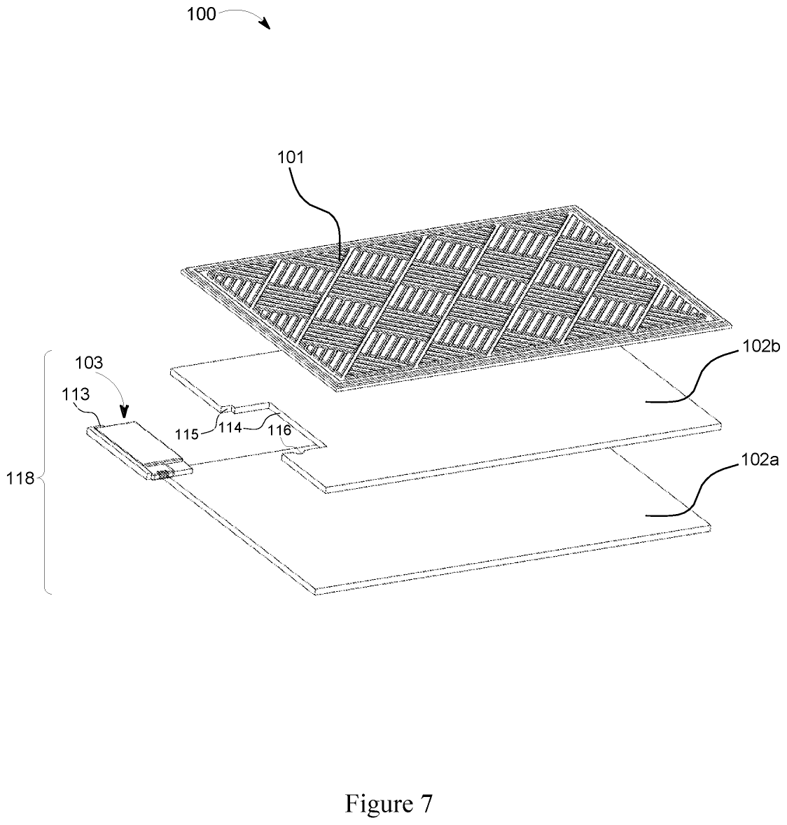

The attachment portions 113 of the safety box 103 may be used for an unremovable, or a removable, attachment of the safety box 103 to an at least one horizontal panel 102. FIGS. 6 and 7 depict an example of the presently disclosed doormat structure 100 which comprises a body 118 and a mat 101. The body 118 comprises two horizontal panels 102a, 102b, and one lockable safety box 103 comprising a front portion 117. The safety box 103 is attached, removably or unremovably, to the horizontal panel 102b, the horizontal panel proximal to the mat 101. A cutout in horizontal panel 102b is illustrated, the cutout comprises a contour 114 designed for fitting the safety box 103. In some embodiments, attachment portions 113 serve to facilitate secure fitting of the safety box 103 into the above-mentioned contour 114. In particular, the attachment portions 113 fit into notch/s 115 in the contour which are designed to accommodate the attachment portions 113 specifically. In the embodiment of FIGS. 6 and 7, only the front portion 117 is accessible to a user from the outside of the doormat structure 100. The portion of the lock 104 which a user must use to unlock the safety box 103 is accessible only when the mat 101 is removed, or partially removed, from the body 118. In some embodiments, the cutout contour 114 comprises lock notch 116 which provides the user with a convenient access to the portion of the lock 104.

In some embodiments, the body 118 comprises a single horizontal panel 102. In other embodiments, the body 118 comprises multiple horizontal panels 102 (for example, 102a and 102b in the present example) which are attached together in a manner according to which the said panels 102 substantially overlap horizontally.

The horizontal panels 102 (for example, 102a and 102b) may be attached to each other, and/or the safety box 103 attached to at least one horizontal panel 102, using any method traditional in the art. Such methods include, without limitation, lamination, adhesive/s, thermal binding, mechanical attachment, or combinations thereof. Means of mechanical attachment may include, without limitation, screws, nails, nuts, bolts, washers, anchors, rivets, clips, staples, tacks, braces, or combinations thereof.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide. For example, when using the term “substantially” herein it may be a value of at least 50%, at least 60%, at least 70%, at least 80%, at least 90%, or at least 99%, or any amount or range therebetween.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A doormat structure comprising:
a body; the body comprises at least one horizontal panel and at least one safety box, the at least one safety box comprising a storage compartment, the storage compartment comprising a storage space;
a mat, wherein the mat is positioned upon the at least one horizontal panel.

2. The doormat structure of claim 1, wherein the body further comprises a vertical wall which extend around the perimeter of the at least one horizontal panel/s.

3. The doormat structure of claim 1, wherein the least one safety box is attached to at least one horizontal panel.

4. The doormat structure of claim 3, wherein the attachment of the at least one safety box to the at least one horizontal panel is removable or unremovable.

5. The doormat structure of claim 4, wherein at least one safety box is lockable via a lock.

6. The doormat structure of claim 5, wherein the lock is selected from a group comprising a combination type lock, latch, bolt lock, keypad lock, smart lock, set of one or more magnet(s), and pin tumble lock.

7. The doormat structure of claim 6, wherein the lock is located in a position selected from a group comprising a position at the perimeter of the body which is accessible to a user, a position at the top side of a horizontal panel which is positioned underneath the mat, a position at the bottom side of a horizontal panel.

8. The doormat structure of claim 7, wherein the safety box is in an open or closed position; and wherein when the safety box is in an open position the storage space is accessible to a user.

9. The doormat structure of claim 8, wherein the storage compartment comprises at least one front portion, and wherein when the safety box is in a closed position the at least one front portion is positioned at the perimeter of the body.

10. The doormat structure of claim 9, wherein when the safety box is in an open position the at least one front portion, and thus the storage compartment, is pulled outwards away from the perimeter of the body, thus exposing the storage space.

11. The doormat structure of claim 8, wherein the at least one horizontal panel comprises an elastic and weatherproof material; and wherein the material is selected from a group comprising vinyl, polyvinyl chloride (PVC), rubber, silicone, neoprene, and polyethylene foam.

12. The doormat structure of claim 8, wherein the safety box comprises material selected from a group comprising ceramic fibers, metal, plastic, steel, and aluminum.

13. The doormat structure of claim 8, wherein the mat comprises a material selected from a group comprising nylon, polypropylene, coir, foam, cotton, microfiber, fabric, fiber brush, or natural rubber.

14. The doormat structure of claim 8, wherein the at least one horizontal panel has a thickness in the range of 0.5 to 1 inch.

15. The doormat structure of claim 8, wherein the body comprises one horizontal panel and at least one safety box attached to the said one horizontal panel.

16. The doormat structure of claim 8, wherein the body comprises two horizontal panels wherein at least one of the said horizontal panels is attached to at least one safety box; and wherein the two horizontal panels are attached together in a manner according to which the said panels substantially overlap horizontally.

17. The doormat structure of claim 16, wherein a first panel of the two horizontal panels is attached to at least one safety box and a second panel of the two horizontal panels is not attached to at least one safety box, and wherein the shape and perimeter of the first horizontal panel and attached at least one safety box are substantially the same as the shape and perimeter of the second horizontal panel.

18. The doormat structure of claim 17, wherein the attachment of the two horizontal panels to each other is achieved via the use of a method selected from a group comprising a use of an adhesive/s, thermal boding process, or mechanical fastener/s.

19. The doormat structure of claim 18, wherein the mechanical fastener/s is selected from a group comprising screws, nails, nuts, bolts, washers, anchors, rivets, clips, staples, tacks, or braces.

20. The doormat structure of claim 8, wherein the body and mat have substantially the same shape and perimeter, and wherein the shape of the body and mat is selected from a group comprising rectangle, square, circle, half-circle, ring, trapezoid, rhombus, ovel, and half-oval.
